(19) United States
(12) Patent Application Publication
(10) Pub. No.: US 2008/0211652 A1
(43) Pub. Date: Sep. 4, 2008

(54) Dynamic Vehicle Display System

(75) Inventors: Richard C. Cope, Duluth, GA (US); John W. Wilson, Smyrna, GA (US); Adrian Kitai, Mississauga (CA)

Correspondence Address: SUTHERLAND ASBILL & BRENNAN LLP, 999 PEACHTREE STREET, N.E., ATLANTA, GA, 30309, US

(73) Assignee: NANOLUMENS ACQUISITION, INC., Norcross, GA (US)

(21) Appl. No.: 11/681,250

(22) Filed: Mar. 2, 2007

(51) Int. Cl. B60Q 1/00

(52) U.S. Cl. 340/461

(57) ABSTRACT

A dynamic and customizable vehicle display system may include a flexible and addressable display panel that is conformable and attachable to a non-planar vehicle surface. A display module may receive data signals from a vehicle and send control signal to generate desired images on the addressable display. The display may operate in a plurality of modes and may switch modes upon the occurrence of a particular event. A user input device may be provided to customize the characteristics of the displayed images and the display module may be programmed to dynamically change image characteristics in response to the occurrence of particular events.

### FIELD OF THE INVENTION

The present invention relates to vehicle display systems and instrument panels, and more particularly, to a vehicle display system that is customizable and dynamic, and easily adaptable for installation in a variety of vehicles and to a variety of vehicle surfaces.

### BACKGROUND

Vehicles, such as automobiles, watercraft, and aircraft, are usually provided with displays or gauges to provide information to the vehicle operator. Typically, a cluster of gauges is arranged to form an instrument panel that is easily viewed by the operator during operation of the vehicle. For example, FIG. 1 shows a prior art automobile instrument panel 100 that includes a speedometer 102, tachometer 104, temperature gauge 106, gear indicator 108, fuel gauge 110, pressure gauge 112, voltmeter 114, and odometer 116. These gauges are traditionally mechanical devices having housings 118 mounted in receiving slots 120 of a base panel 122.

During manufacture of the instrument panel 100, the gauge housings 118 are inserted into the base panel 122 through the receiving slots 120 so that each gauge is provided in a fixed location of the instrument panel 100. For example, in the prior art instrument panel 100 shown in FIG. 1, a tachometer gauge 104 is shown in a fixed location at a right portion of the instrument panel 100 in a first receiving slot 120A and a speedometer gauge 102 is located at a fixed position at a left portion of the instrument panel 100 in a second receiving slot 120B. The assembled instrument panel 100 is then installed in a vehicle, such as by mounting the instrument panel 100 in a receiving area of a dashboard and connecting the gauges to the vehicle's monitoring system or systems.

While fit for its intended purpose, this prior art instrument panel has several drawbacks. First, installation of such a panel is complex and time consuming, requiring individual gauges to be installed in the base panel 122. The inflexibility of the base panel 122 limits the points in the assembly line process in which the base panel 122 can be installed, and makes handling and installation of the base panel 122 difficult. In addition, the base panel 122 typically occupies valuable space that could potentially be used for other purposes. The weight of the instrument panel 100 decreases vehicle performance and the rigidity of the base panel 122 raises safety concerns. The rigid base panel 122 also prevents the instrument panel from being easily adapted for installation in a variety of different makes of vehicles, which may have different dashboard contours, configurations, and spacing requirements. Furthermore, the instrument panel 100 is not easily changed or updated, as changes to the instrument panel 100 typically require updating the base panel 122 and/or the gauges. What is needed is an instrument panel that is lightweight, compact, easily installable, and adaptable for installation in a variety of different vehicles and on a variety of different shaped vehicle surfaces.

A further disadvantage of prior art instrument panels is the limited display characteristics. For example, the mechanical gauges employed in the prior art instrument panel 100 of FIG. 1 are fixed in location, shape, size, and color. In addition, the prior art base panel 122 has partitions 140 located between the gauges which decreases the available area that may be used for display purposes. This fixed arrangement of prior art gauges often results in unused space. For example, because the instrument panel may require fixed gauges that are not easily changed, then portions of the instrument panel may be reserved for optional gauges which some users may elect not to purchase. These reserved areas are then left blank, taking up space in the instrument panel that could otherwise be used for displays.

These aforementioned problems have led to an increased interest in the use of addressable displays, such as Liquid Crystal Displays (LCDs), to provide information to vehicle operators. However, prior art addressable displays have several drawbacks which have limited their use in vehicles. First, addressable displays tend to be expensive, and many are of insufficient quality or brightness for use as an instrument panel. In addition, addressable displays, such as LCDs, tend to be rigid and planar, making them difficult to incorporate into the non-planar surfaces found in most vehicles. Furthermore, addressable displays tend to be heavy, resulting in decreased vehicle performance, and bulky, taking up valuable space in a vehicle cockpit. Many addressable displays, such as LCDs, also require large light sources for backlighting, which can generate undesirable heat levels. Still further, many addressable displays have power requirements which are too high for use in most vehicles. Thus, the use of addressable displays in vehicles has generally been limited to one or two small displays, such as an automobile navigation display that is not located in the main instrument panel. U.S. Patent Publication No. 2005/0030256A1 to Tubidis el al. entitled “Conformable Vehicle Display” discloses the concept of using an addressable display in a vehicle. In Tubidis, a flexible display is coupled to a rigid substrate which in turn is coupled to a surface of a vehicle. Both the display and the substrate are transparent so that when the display is not activated an operator can see the surface of the vehicle to which the display and the rigid substrate are attached. Tubidis has the disadvantage of using an additional rigid substrate for mounting the display on a vehicle surface.

Another challenge facing vehicle instrument panel designers and manufacturers is providing an increasing amount of available data to a vehicle operator in an efficient and user-friendly way in the limited space of a vehicle. For example, automobiles are now provided with tire pressure monitoring systems, hybrid power systems, telecommunications equipment, and other systems and equipment that were not available just a few years ago. It would be desirable to provide this information to an operator in an easily viewable manner, such as in an area near the operator's line of sight when operating the vehicle.

One approach to solving this problem is to provide multiple layers of displays as disclosed in U.S. Pat. No. 6,224,222 to Inoguchi et al. entitled “Combined Display Panel.” That patent discloses providing a transparent electroluminescent panel that overlaps a part of a conventional instrument panel for use in an automobile. While fit for its intended purpose, that patent adds another layer of complexity to the instrument panel as well as an additional display to the vehicle. In addition, it requires lighting changes on other portions of the display.

Another disadvantage of the prior art instrument panel is its lack of customization. Manufacturers would prefer utilizing one instrument panel design for a host of different vehicle models, to developing and installing different instrument panel designs for each model. Manufacturers would also like to easily change the attributes of an instrument panel, such as adding a new display for a newly developed technology, changing the size or shape of an instrument panel depending upon the options provided on the vehicle, adapting an instrument panel to the preferences of a different markets, or updating an instrument panel to new standards or regulations. For example, even a relatively minor change to an instrument panel layout can require re-working a base panel and/or gauges which may take months to complete. What is needed is an instrument panel that is easily updated or changed.

In addition, it would be desirable to allow an operator of a vehicle to adjust the instrument panel to his or her own preferences. For example, a vehicle may be used by more than one operator. A first operator may desire to have a large tachometer located at the center of the control panel, whereas a second user may prefer a smaller tachometer offset from the center. Presently, the two of these users cannot be accommodated by a single instrument panel. The typical prior art instrument panel employs gauges in fixed locations with fixed display attributes such as size, shape, color, and brightness. To change the arrangement of the gauges on the instrument panel, for example to change the location of a tachometer, may require reworking the base panel and installing a new gauge at a new location. Modifying or updating a prior art instrument panel is thus a difficult and time-consuming task that may take a manufacturer a year or more to accomplish, hampering the ability of vehicle manufacturers to quickly update vehicle models.

There have been some recent attempts to provide some degree of user-customizability to instrument panels but these attempts have been limited to minor attribute changes such as changing the brightness or color of a gauge by installing additional lighting. For example, U.S. Pat. No. 5,695,269 to Lippman et al. entitled “Multi-Color Display Lighting by LED” discloses an LCD display backlit by a main light pipe, and LEDs of a first color along one edge which flood the display with the first color, and an LED of a second color coupled by a second light pipe along another edge to introduce light to local areas of the main light pipe. Filters of the second color over the local areas are illuminated by the second color LED. As previously mentioned, LCDs have several undesirable qualities such as their rigidity, flatness, heat, power requirements and weight which make it difficult to form an integrated vehicle instrument panel.

U.S. Pat. No. 5,975,728 to Weyer entitled “Method and Apparatus for Providing User Selectable Multi-Color Automobile Instrument Panel Illumination” discloses an instrument panel that is provided with a plurality of variously colored illumination sources in which the intensity of each color is individually controllable, thereby allowing the user to select both intensity and hue of instrument illumination.

U.S. Pat. No. 6,575,607 to Klemish et al. entitled “User Controllable Color Lighting in a Vehicle Instrument Cluster” discloses a user controllable lighting system for a vehicle instrument cluster that includes a selection apparatus to select a color scheme for individual gauge area components; an illumination apparatus to illuminate the individual gauge area components in accordance with selections made by the selection apparatus; and control apparatus connected to the selection apparatus and to the illumination apparatus to receive the selections made by the selection apparatus and to furnish instructions to the illumination apparatus.

While fit for their intended purposes, these prior art displays generally only offer customization of the color or brightness of the gauges. They do not address other display characteristics such as the size, shape, or location of the gauges or the instrument panel itself. Thus, what is needed is an instrument panel that is customizable by a vehicle operator.

Another disadvantage of the prior art instrument panel is its inability to change display characteristics dynamically in response to an event such as the vehicle's operation. As mentioned above, the gauges of the prior art instrument panel are static gauges having fixed locations and display characteristics. This static gauge arrangement fails to address the fact that the relevance of a particular gauge may change due to the occurrence of an event. For example, if a vehicle is low on fuel it may be desirable to more prominently display a fuel gauge, or if a vehicle is exceeding the recommended rpms, it may be desirable to more prominently display a tachometer. These changeable gauge characteristics could include changing the gauge location, size, shape, appearance, or other attributes of the instrument panel. What is needed is a dynamic instrument panel that can automatically change characteristics of gauges in response to the occurrence of an event, such as an event associated with the operation of the vehicle, such as rpms, fuel level, speed, oil temperature, turn signals, gear position, etc., or some other event such as the receipt of a phone call, email, etc.

One attempt at providing a dynamic instrument panel is disclosed in U.S. Pat. No. 6,717,376 to Lys et al. entitled “Automotive Information Systems.” That patent discloses an intelligent lighting device that can receive signals and change illumination conditions, such as the hue, saturation, and brightness, as a result of the received signals. It discloses illuminating the dashboard of a vehicle with an LED device with color changing ability that may change colors as the result of an input (Col. 20 lines 56-67). For example, a green LED and a red LED may be provided to a gauge that could display a different color depending on the engine speed. But like the other prior art discussed above, the Lys device teaches changing the color and perhaps brightness of light associated with a gauge, it does not teach or disclose changing other characteristics of an instrument panel such as changing the size, location, shape, and the additional attributes of a gauge.

What is needed is an instrument panel than can be easily incorporated into a vehicle and modified for use in a plurality of different vehicle designs. What is also needed is a vehicle instrument panel that can be easily updated or modified by a manufacturer or retailer of the instrument panel or vehicle. What is also needed is a vehicle instrument panel that is customizable by a user. What is also needed is a dynamic instrument panel that can intelligently change characteristics of the display when a predetermined parameter is met, such as the occurrence of a predetermined event, such as an event associated with the operation of the vehicle or an external event.

### SUMMARY OF THE INVENTION

The present invention provides a vehicle display system that is easily adaptable for installation in a variety of vehicles. In one exemplary embodiment the vehicle display of the present invention includes a flexible display that can be easily coupled to a variety of vehicle surfaces including planar and non-planar surfaces.

The present invention also provides a customizable vehicle display system that may include one or more addressable display panels, in which the characteristics of the displayed images are customizable by a user. In an exemplary embodiment, the dynamic display system is provided with a plurality of operational modes which can be selected by a user. The various operational modes can be stored in a display module and retrieved for use by a user.

The present invention also provides a dynamic vehicle display system which can automatically change attributes of the displayed images in accordance with predetermined rules. In an exemplary embodiment rules for changing the characteristics of a display are developed so that when a specified parameter is met characteristics of the display are changed. In one exemplary embodiment the characteristics are changed based upon the operation of the vehicle or in response to the occurrence of a particular event.

In an exemplary embodiment, the vehicle display system takes the form of an instrument panel having a flexible and addressable display panel that is adapted to provide images of one or more vehicle gauges. The flexible display may be shaped to conform to a non-planar or curved surface of a vehicle dashboard and thus is easily adapted for installation on a wide variety of vehicles without the constraints of the prior art rigid panel and mechanical gauge systems. The instrument panel may further comprise a display module that is coupled to the flexible addressable display and adapted to receive data signals from a vehicle or an external source and provide control signals to the addressable display to generate a desired gauge image. In an exemplary embodiment, the flexible display may be an addressable electroluminescent display having row and column drivers for illuminating various pixels to generate a desired image. The characteristics of the images displayed by the instrument panel can be easily updated or modified by changing the control signals sent to the display. The display module may be provided with a variety of operational modes which may be selected by a user. This allows the instrument panel to be customized for a particular vehicle or a particular market in which the instrument panel will be sold, as well as customized to the particular operator of the vehicle. Different operational modes may also be automatically selected based upon predetermined rules or schemes. This allows characteristics of the gauges to change automatically in response to the operation of the vehicle or some other event.

An exemplary method of the invention comprises providing a flexible instrument panel having an addressable display, and conforming the instrument panel to a receiving area of a vehicle. An exemplary method may further comprise coupling the display to an electronic system of the vehicle and programming the display module to generate one or more images having desired characteristics.

The addressability of the display allows for improved display characteristics over prior art instrument panels. For example, the gauges are not fixed in a particular location but may be moved to various locations of the display as desired. In addition, various characteristics of the gauges, such as sizes, shapes, colors, etc., can be modified.

The vehicle display system of the present invention may comprise one or more display panels of various sizes and shapes. In one exemplary embodiment, a single display panel is provided which is adapted to provide images of a plurality of gauges thereon and to serve as a vehicle instrument panel. By providing multiple gauges on a single panel the potential viewing area of the instrument panel is increased as partitions between the gauges are eliminated. In addition, space need not be reserved for gauges associated with optional equipment, as the display can be easily adapted to display various gauges by adjusting the display electronically. For example, a user may be offered the option to select the particular gauges to be displayed and the desired display characteristics for each gauge. If fewer gauges are selected the gauges may be enlarged to occupy display space that would normally be reserved for optional gauges.

In an exemplary embodiment, a plurality of addressable and flexible display panels may be provided. The flexibility and addressability of the display panels allows the display panels to be provided in a variety of different locations of the vehicle including non-planar and curved surfaces. The display panels may be used in areas of the vehicle other than the main instrument panel, such as by way of example and not limitation, in a headrest, sun visor, rear view mirror, side mirror, seat back, body panels, etc. In one embodiment, the vehicle display system may form an instrument panel having one or more display panels extending along the base of the windshield across the width of the vehicle interior, such as from a driver's side window to a passenger's side window in an automobile.

In another aspect of the invention, a user-customizable instrument panel is provided. In one exemplary embodiment, the customizable instrument panel comprises an addressable display adapted to provide an image of one or more gauges, a user input device adapted to receive instructions from a user, and a display module adapted to receive input from the user input device and generate a desired image on the addressable display in response to the user input. An exemplary method of the invention comprises receiving an input from a user and changing the characteristics of an instrument panel in response to the user input. The characteristics that may be changed include, by way of example and not limitation, the size, color, brightness, shape, and arrangement of displayed images.

In another aspect of the invention, a dynamic instrument panel is provided that is adapted to change the characteristics of one or more gauges of the instrument panel in response to the occurrence of an event, such as an event related to the operation of a vehicle or input from an external device. In an exemplary embodiment, the dynamic instrument panel comprises an addressable display and a display module adapted to receive data from the vehicle and effect a change in a display characteristic in response to the data signal. An exemplary method of the invention comprises receiving a data signal from a vehicle, determining from the data signal whether to change a characteristic of the display, and, if so, modifying a characteristic of the display.

In another aspect of the invention, the display system establishes communication with an external device such as a digital music player, video player, telecommunications device, etc. and displays data associated with the external device. In an exemplary embodiment the display system comprises an interface for interfacing with an external device, a display module adapted to receive data from the external device, and a display coupled to the display module adapted to display images associated with the external device.

### BRIEF DESCRIPTION OF THE DRAWINGS

FIG. 1 shows a perspective view of a prior art automobile instrument panel.

FIG. 2A shows a perspective view of an instrument panel in accordance with an exemplary embodiment of the invention.

FIG. 2B shows an enlarged view of the instrument panel of FIG. 2A.

FIG. 2C shows a side view of the pixel of FIG. 2B.

FIGS. 3A-3C show exemplary embodiments of flexible displays that may be used in conjunction with the present invention.

FIG. 4 shows an exemplary method of the invention.

FIG. 5 shows a block diagram of a vehicle display system in accordance with an exemplary embodiment of the invention.

FIG. 6 shows an image provided by an instrument panel in accordance with an exemplary embodiment of the invention.

FIG. 7 shows a flow diagram of an exemplary method of the invention.

FIG. 8 shows a block diagram of a customizable instrument panel in accordance with an exemplary embodiment of the invention.

FIGS. 9A-9E show arrangements of gauges of a vehicle display system in accordance with exemplary embodiments of the invention.

FIG. 10 shows a flow diagram of an exemplary method of the invention.

FIG. 11 shows a flow diagram of an exemplary method of the invention.

FIGS. 12A-12B show images of a speedometer provided by an instrument panel in accordance with an exemplary embodiment of the invention.

FIG. 13 shows a flow diagram of an exemplary method of the invention.

FIG. 14 shows a block diagram of a customizable instrument panel system in accordance with an exemplary embodiment of the invention.

FIG. 15 shows a flow diagram of an exemplary method of the invention.

FIG. 16 shows an instrument panel in accordance with an exemplary embodiment of the invention.

FIG. 17 shows a block diagram of an embodiment of the invention employing a plurality of display panels.

### DETAILED DESCRIPTION

As required, exemplary embodiments of the present invention are disclosed herein. These embodiments are meant to be examples of various ways of implementing the invention, and it will be understood that the invention may be embodied in alternative forms. The figures are not to scale and some features may be exaggerated or minimized to show details of particular elements, while related elements may have been eliminated to prevent obscuring novel aspects. Therefore, specific structural and functional details disclosed herein are not to be interpreted as limiting, but merely as a basis for the claims and as a representative basis for teaching one skilled in the art to variously employ the present invention.

For purposes of teaching, the exemplary embodiments disclosed herein are discussed in the context of an automobile. However, the present invention is applicable to other vehicles as well, such as, by way of example and not limitation, aircraft, watercraft, trucks, ATVs, motorcycles, etc., as well as vehicle simulators and other simulation devices. The term “gauge” as used herein means an information indicator and the term is meant to include all variety of indicators, such as, by way of example and not limitation, meters, dials, warning lights, etc., as well as images generated on a display. Thus, an LCD clock and a speedometer may both considered gauges. In the following description and claims, the terms “coupled” along with its derivatives, may be used. “Coupled” may mean that two or more elements are in direct physical or electrical contact. However, “coupled” may also mean that two or more elements are not in direct contact with each other, but yet still cooperate or interact with each other such as when two elements are in communication with one another but not touching.

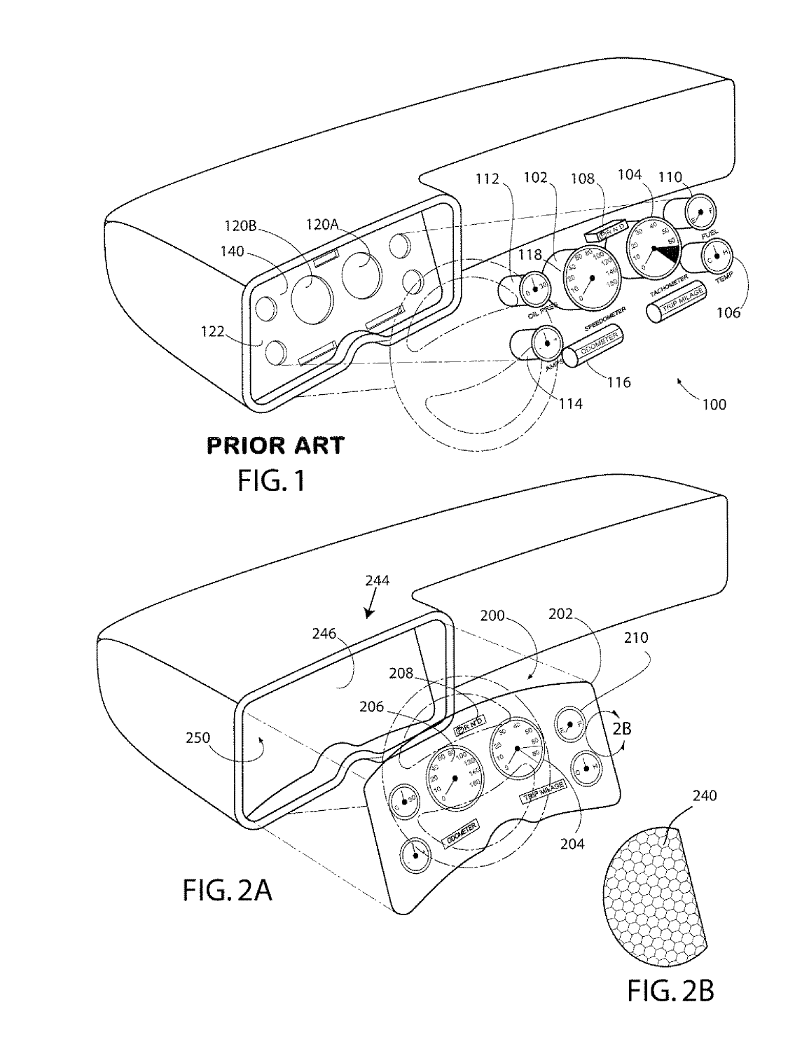

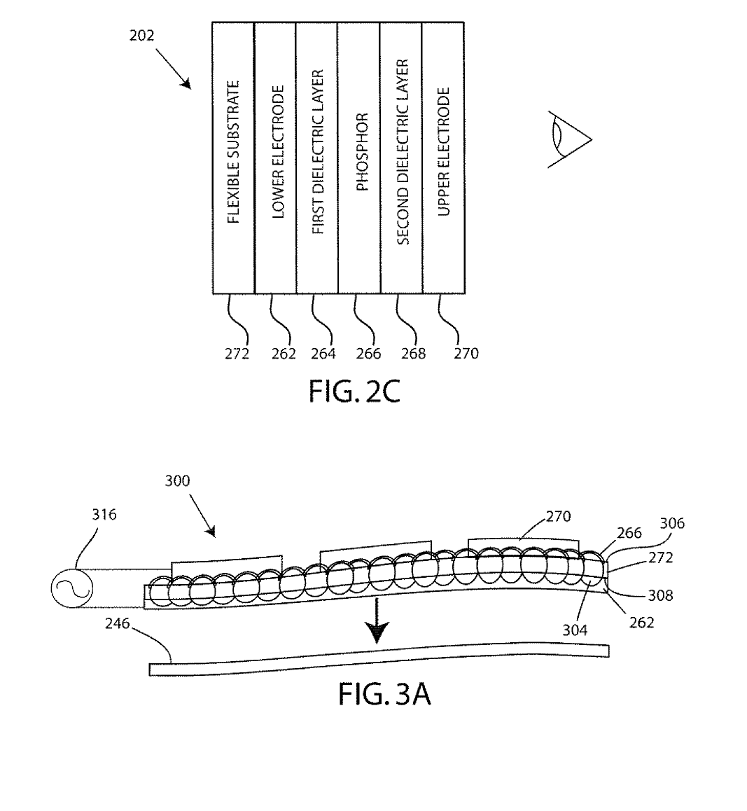

Turning to the figures, wherein like numerals represent like features throughout the views, FIG. 2A shows an exemplary embodiment of an improved instrument panel 200 comprising a display 202. The display 202 is preferably addressable and adapted to display images, such as images representing the gauges of a vehicle. For example, the display 202 may include a plurality of addressable pixels 240 (FIG. 2B) which can be manipulated to generate a desired image. In the exemplary embodiment of FIG. 2A, the display 202 is adapted to display images related to vehicle status, operation and performance, such as images of a tachometer 204, speedometer, 206, gear indicator 208, fuel indicator 210, etc., which define vehicle gauges. The arrangement of these gauges is similar to that of the prior art instrument panel 100 shown in FIG. 1 but the display 202 could include other gauges. For example, gauges may be provided that display information associated with other variables, such as data associated with ambient conditions, location, heading, etc. or information associated with other devices, such as telecommunications devices, audio devices, video devices, etc. As shown in FIG. 2A, an instrument panel 200 incorporating the flexible display 202 may be adapted to conform to the non-planar surface 246 of a vehicle, such as a surface of a dashboard 244.

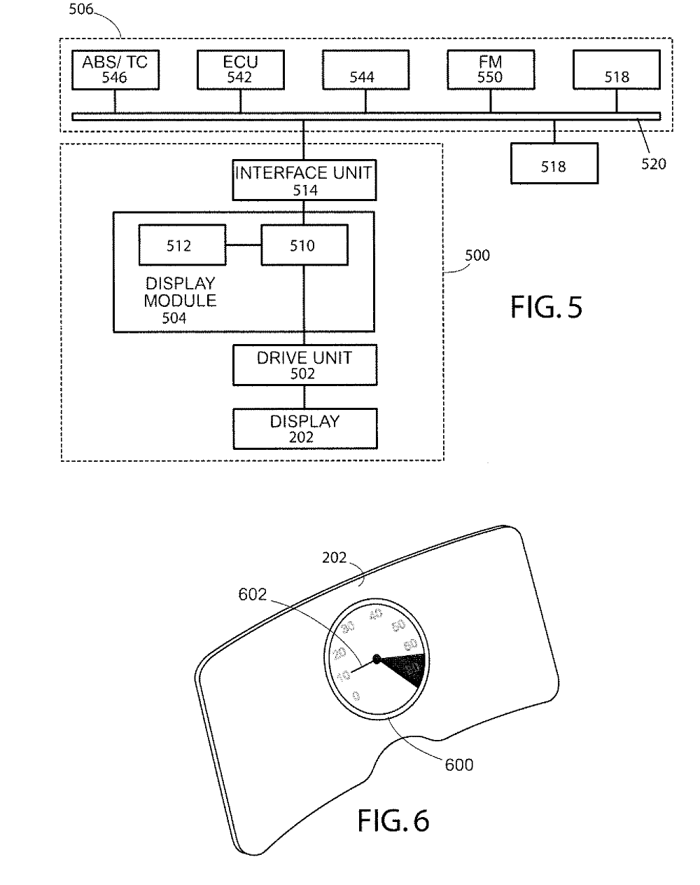

As shown in cross section in FIG. 2C, the addressable display 202 may be in the form of a flexible electroluminescent display that generally comprises a first electrode layer 262, a first dielectric layer 264, a phosphor layer 266, a second dielectric layer 268, a second electrode layer 270, and a flexible substrate 272. The first 262 and second 270 electrode layers may be arranged in orthogonal columns and rows respectively to form a matrix-addressed array. The cross over of the first 262 and second 270 electrodes defines an addressable pixel 240 which may be driven to emit light having the required characteristics to generate a desired image. A drive unit 502 (FIG. 5) may be provided to supply the appropriate voltages so that the phosphor layer 266 generates light in a desired color and pattern. The pixels 240 may include a variety of different phosphors that may be arranged to form an emissive color display and additional charge injection layers may be added.

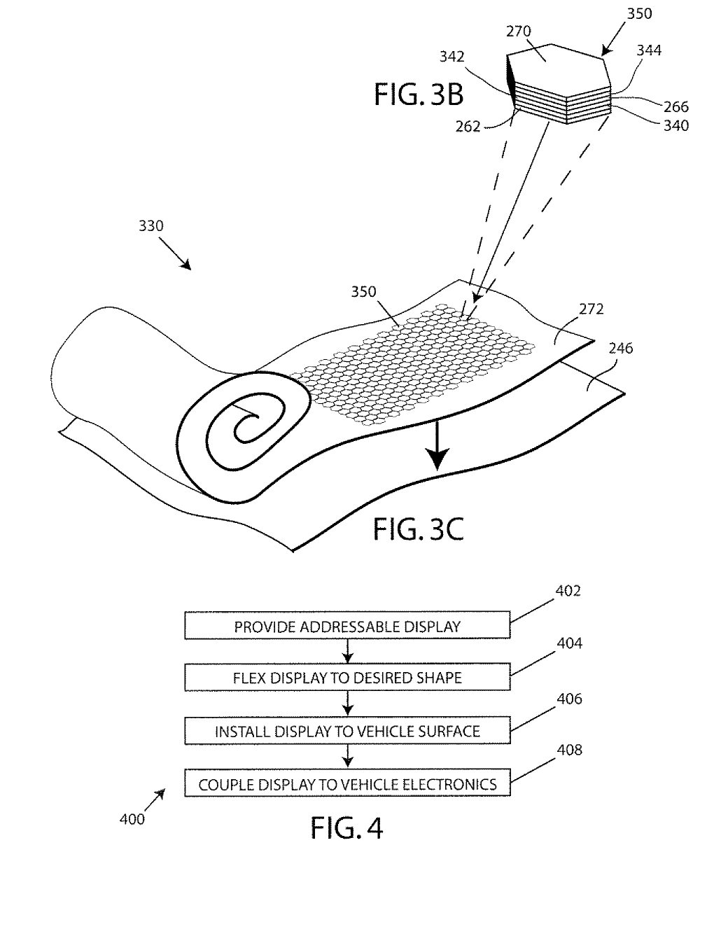

In one exemplary embodiment, the flexible display panel 202 may be in the form of a Sphere Supported Thin Film Electroluminescent (SSTFEL) device 300 as shown in FIG. 3A and described in WIPO Publication No. WO 2005/024951 entitled “Sphere Supported Thin Film Phosphor EL Devices”, which is hereby incorporated by reference in its entirety herein. The SSTFEL device 300 may comprise: a flexible, electrically insulated substrate 272 having opposed surfaces 306; 308; an array of generally spherical dielectric particles 304 embedded in the flexible, electrically insulated substrate 272 with each of the spherical dielectric particles 304 having a first portion protruding through one of the opposed surfaces 306 and a second portion protruding though the other of said opposed surfaces 308; an electroluminescent phosphor layer 266 deposited on the first portion of each spherical dielectric particles 304; a continuous electrically conductive, substantially transparent electrode layer 270 located on the top surfaces of the electroluminescent phosphor layer 266 and areas of the flexible electrically insulating substrate 272 located between the top surfaces of the electroluminescent phosphor layer 266; and a continuous electrically conductive electrode layer 262 coated on the second portion of the spherical dielectric particles 304 and areas of the flexible, electrically insulated substrate 272 located between the second portions of the spherical dielectric particles 304, means 316 for applying a voltage between the continuous electrically conductive, substantially transparent electrode layer 270 and the continuous electrically conductive electrode layer 262. The SSTFEL device may be flexed to conform to a surface 246 of a vehicle and attached directly thereto by various means. This arrangement may be encapsulated in a flexible cover (not shown).

In the embodiment of the SSTFEL device 300 shown in FIG. 3A, a phosphor layer 266 is deposited onto the top surface of BaTiO₃ spheres 304. A thin SrTi0₃ layer (not shown) may be deposited onto the phosphor layer 266 for effective charge injection into the phosphor layer 266. The BaTiO₃ spheres 304 may be embedded within the polymer layer 272 with the top and bottom areas of the BaTiO₃ spheres 304 exposed. The top area of the BaTiO₃ spheres 304 and the surrounding polymer 272 may be coated with a transparent electrically conducting electrode 270, such as ITO; the bottom area of the BaTiO₃ spheres 304 and surrounding polymer 272 may be coated with another electrically conducting electrode 262, which may be opaque. Any EL phosphor material may be used including, but not limited to, metal oxide or sulfide based EL materials. For example, the sulfide phosphor may be any one of ZnS:Mn or BaAl₂S₄Eu, or BaAl₄S₇:Eu. The oxide phosphors may preferably be any one of Zn2_{S}SiO_{0.5}Ge_{0.5}O₄:Mn, Zn₂SiO₄:Mn, or Ga₂O₃:Eu and CaAl₂O₄:Eu.

In another embodiment, a flexible display 330 may be in the form of a nixel-based device as shown in FIGS. 3B-C and disclosed in U.S. patent application Ser. No. 11/526,661 entitled “EL Apparatus and Display Incorporating Same” which is also incorporated by reference herein in its entirety. A nixel 350 is an individually sized and shaped EL apparatus that may be used to form an EL display. Nixels 350 may be manufactured independently and combined with other nixels 350 to form a pixel, a subpixel or a plurality of pixels or subpixels for a display. Nixels can be formed in a variety of shapes and sizes to suit a variety of display applications. As shown in FIG. 3B, a nixel of an exemplary embodiment of the present invention may include a ceramic substrate 340, a first charge injection layer 342 on an upper surface of the ceramic substrate 340, a phosphor layer 266 on top of the first charge injection layer 342, a second charge injection layer 344 on top of the phosphor layer 266, an upper electrode 270 on the upper surface of the second charge injection layer 344 and a lower electrode 262 on the lower surface of the ceramic substrate 340.

As shown in FIG. 3C a plurality of nixels 350 can be attached to a flexible substrate 272 by various means such as by a conductive adhesive and the nixels electrically coupled to provide row and column electrodes and form a flexible EL display. The flexible display 330 may then be attached to a vehicle surface 246 so that it conforms to the non-planar surface.

In another embodiment, the display panel may be in the form of a flexible EL display as disclosed in U.S. patent application Ser. No. 11/535,377 entitled Electroluminescent Display Apparatus and Methods, which is also incorporated by reference in its entirety herein.

FIG. 4 shows an exemplary method 400 of incorporating an instrument panel 200 into a vehicle. At block 402 an addressable and flexible display panel 202 is provided. At block 404 the flexible display panel 202 is manipulated to a desired shape for installation at a surface of a vehicle. For example, the display panel 202 may be flexed to conform to a non-planar surface 244 of a receiving area 250 of a vehicle dashboard 244. At block 406 the display panel 202 is installed in the vehicle. For example, the display panel 202 may be installed in a dashboard receiving area using various means such as using fasteners, adhesives, mounting brackets, etc. The flexibility and robustness of the display panel 202 allows it to be directly attached to a variety of different vehicle surfaces including planar and non-planar surfaces to which it can conform. At block 408 the instrument panel may also be coupled to the electronic system of the vehicle as discussed in more detail below. The flexibility and thinness of the display panel allows for a variety of different installation surfaces and removes the need for large base panels and generally planar surfaces in the vehicle. As discussed in more detail below, the display panel may also be incorporated into other areas of a vehicle.

FIG. 5 shows an exemplary embodiment of a vehicle display system 500 in accordance with the present invention that includes an addressable display panel 202 and a drive unit 502. The drive unit 502 is adapted to provide appropriate signals to the display panel 202 so that a desired image is generated on the display panel 202. In an exemplary embodiment, the drive unit is a voltage driver adapted for use with a SSTFEL display that provides appropriate drive voltages to the display. The image generated by the display panel 202 may be a representation of one or more gauges associated with a vehicle, such as a tachometer, speedometer, gear indicator, etc., as discussed above, or other images as discussed in more detail below.

The drive unit 502 may include a processor and drive circuitry (not shown) coupled to the row 262 and column electrodes 272 of the display panel 202 (FIG. 3). Elements commonly provided in displays such as a power source are not shown so as to not obscure novel aspects of the invention. The drive unit 502 is adapted to control the light emitted from the display pixels 240 by supplying drive signals to the display panel 202 to increase or decrease the voltage at a pixel 240 to turn the pixel on or off and manage the emission of light from the pixels 240 to generate desired images on the display panel 202.

The vehicle display system 500 may also include a display module 504 that is coupled to the drive unit 502 and the electronic system 506 of a vehicle. The display module 504 is adapted to receive data from the vehicle's electronic system 506 and generate control signals to the drive unit 502 to generate an appropriate image on the display panel 202. The display module 504 may be hardware, software, and/or firmware. In the exemplary embodiment shown in FIG. 5, the display module 504 comprises a processor 510 coupled to a memory 512.

The processor 510 may be adapted to receive data signals from the vehicle's electronic system 506 and generate corresponding control signals to the drive unit 502. The memory 512 may store the necessary programs to operate the processor 510. As discussed in more detail below, a variety of display schemes or modes may be stored in memory 512. These display schemes may be retrieved and used by the processor 510 to govern the characteristics of the images displayed in accordance with the particular operational mode. The different modes may be selected by a user or automatically based upon predetermined criteria such as the occurrence of a particular event during operation of the vehicle. The memory 512 may be read only memory (ROM), random access memory (RAM) or some other type memory as the design requires.

The vehicle electronics system 506 may include a variety of controllers that monitor the vehicle, send and receive related data, and perform various actions. For example, controllers may include sensors, monitors, processors and other components known in the art that monitor the vehicle and send related data signals. In the embodiment shown in FIG. 5, the vehicle electronic system 506 includes an engine control unit (ECU) 542 which monitors the vehicle's engine, a transmission controller 544 that monitors the vehicle's transmission, an anti-lock brake/traction control (ABS/TC) module 546 that monitors braking and traction variables, and a fault module (FM) 550 that receives and records diagnostic data from other controllers. These controllers may send and receive data over a data bus 520. For example, the ABS/TC controller 546 may detect slippage of a wheel and send data along the data bus 520 that may be retrieved by the ECU 542, which may adjust fuel injection, ignition timing, or other engine parameters, and/or the transmission controller 544 which may change the power applied to a particular wheel.

As part of the electronics system 506, an interface unit 514 may also be provided that is adapted to interface with the vehicle display system 500. For example, the interface unit 514 may receive data signals from the electronic system controllers in a first format and provide this data to the display module 504 in a second format compatible with the display module 504. The display module 504 may thus be coupled to the interface unit 514 and receive appropriate data signals that provide information regarding the vehicle's operation.

The interface unit 514 may be a processor that receives data signals from vehicle sensors and provides this data to the vehicle display system 500 in a readable form. For example, the interface unit 514 may receive data from sensors 518 as to the operation of the vehicle, such as, by way of example and not limitation, the revolutions of the engine, the pressure in the vehicle's tires, the amount of fuel and oxygen being provided to the engine, the gear the transmission is in, etc. In addition, other devices not shown in the figures may supply information to the interface unit 514 through the communications bus 520. The interface unit 514 may include a variety of electronic components such as analog to digital converters, etc. know in the art that allow the interface unit 514 to receive data from the vehicle's sensors and monitoring systems and provide this data in a readable form to the display module 504.

The interface unit 514 may be adapted to provide this data to the display module 504 via a data signal For example, the interface unit 514 may receive data from the transmission controller 544 regarding the present revolutions of the engine. The interface module 514 can then format this data into a data signal that is understandable by the display module 504 and send the data signal to the display module 504. For example, the interface module 514 may send a data signal having a header identifying the parameter the data relates to and a body that indicates the parameter's value.

The display module 504 is adapted to receive the data signal from the interface module 514 and generate an associated control signal. The control signal may be sent to the drive unit 502 which generates drive signals to generate a desired image on the display panel 202 in response to the control signal. For example, the processor 510 may be adapted to receive a data signal from the interface module 514 and generate a desired control signal that can be understood by the drive unit 502. The drive unit 502 may then send appropriate drive signals to generate the voltages required to cause pixels in the display panel 202 to emit light and generate a desired image. As discussed in more detail below, the particular control signal sent by the display module 504 may depend upon the current operational mode of the display module 504.

The memory 512 may be provided with a variety of different schemes for generating control signals to provide different images on the display 202. Under a first scheme, the control signal may change one or more characteristics of the display. For example, if the data signal from the interface unit 514 indicates that the vehicle is operating at 1,000 rpm, then the display module 504 may receive and process the data signal and send a control signal to the drive unit 502 instructing the drive unit 502 to manipulate the display panel 202 to generate an image of a tachometer indicating 1000 rpm as shown in FIG. 6. As discussed in more detail below, the display module 504 may also be adapted to change other characteristics of the display image in accordance with the operation of the vehicle or the occurrence of a particular event. For example, if the data signal indicates that the rpms are beyond a predetermined threshold, a different image may be displayed, such as an enlarged tachometer shown in red color.

This process of generating a gauge image on the display may be repeated so that the displayed image of the tachometer is continuously updated. For example, the tachometer image 600 could be refreshed at a sufficient rate to show movement of the tachometer “needle” 602 as the rpms increase or decrease to emulate a mechanical analog device. Although the imaged gauges shown on the display panel discussed herein resemble that of mechanical gauges, the images may take on a variety of different forms, such as digital read outs, bar graphs, pie charts, etc.

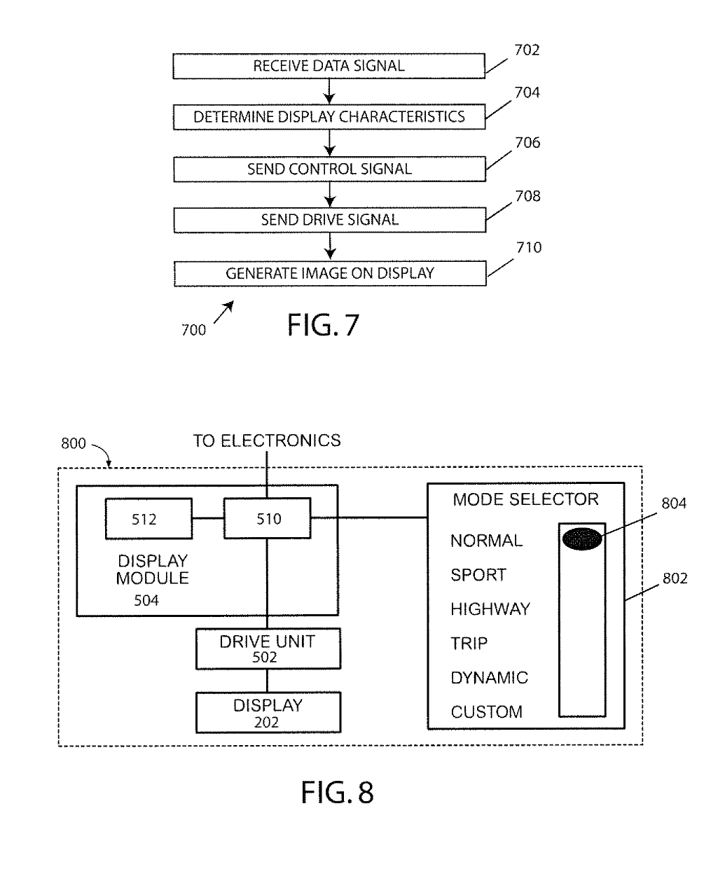

FIG. 7 shows an exemplary method 700 of the invention for displaying images of an instrument panel. At block 702 a data signal is received. For example, as discussed above, a data signal sent from an interface unit 514 of a vehicle or from another source may be received by a display module 504. At block 704 the characteristics of the display to be generated is determined. For example, the processor 510 determines what image is to be displayed on the display panel. As previously mentioned, a plurality of different modes or schemes can be stored in memory and the characteristics of the desired image to be displayed may vary depending upon which scheme or mode is employed. As discussed in more detail below, the data signal may include data that triggers a change in the scheme or mode used by the processor in determining the characteristics of the desired image.

Once the desired characteristics of the image are determined, at block 706 a control signal is generated in accordance with those desired characteristics. For example, the processor 510 of the display module 504 may have received and decoded a data signal indicating the speed of the vehicle and the desired image is of a speedometer indicating that speed. A corresponding control signal indicating these parameters is sent to a drive unit 502.

At block 708 a drive signal may be generated in response to the control signal and the drive signal and sent to the display panel. For example, the drive unit 502 may receive control signals from the display module 504 and generate corresponding drive signals that are sent to the display panel 202 to generate a desired image on the display panel 202.

At block 710 a desired image is generated on the display panel in response to the drive signals. For example, in the exemplary embodiment where the display panel is an addressable EL panel, the driver circuitry may provide voltages to the display panel 202 so that the appropriate pixels are illuminated in the display panel 202 to generate the desired image.

The addressable vehicle instrument panel of the present invention allows for the display characteristics of the instrument panel to be easily modified by providing different operational modes that are adapted to generate images having different characteristics. By way of example and not limitation, some display characteristics that can be modified include the size, orientation, location, color, brightness, scale, and shape of the gauges. Thus, the methods and apparatus of the invention allow a manufacturer to customize display attributes of the instrument panel to the particular vehicle in which it will be installed.

For example, a vehicle display system of the present invention may be programmed to display images based upon the particular market in which the vehicle will be sold, such as selecting between a first mode that displays speeds in miles per hour and a second mode that displays speeds in kilometers per hour. Various other modes may be selected depending upon what options and features are available on a vehicle. This customizability allows the instrument panel to be used in a wide variety of vehicles that may be provided with various optional gauges.

In another aspect of the invention, a user customizable vehicle display system is provided in the form of a vehicle instrument panel. FIG. 8 shows a user customizable block diagram 800 in accordance with an exemplary embodiment of the invention that includes an addressable display panel 202, a drive unit 502, a display module 504, and a user input device 802. The display panel 202, drive unit 502, and display module 504 have been discussed above in connection with FIG. 4 and will not be discussed in detail again here. As also discussed above, the display 202 is preferably addressable so that the characteristics of the images shown on the instrument panel 202 can be customized by changing the control and drive signals sent to the display panel 202.

A user input device 802 is provided to receive input from a user, such as the selection of a preferred operational mode of the display module 504 so that a desired gauge arrangement is provided on the display panel 202. In the embodiment shown in FIG. 8, the user input device 802 is in the form of a mode selector switch 804 coupled to the display module 504. Other input devices known in the art may be used such as a scroll wheel, keypad, voice activation system, etc.

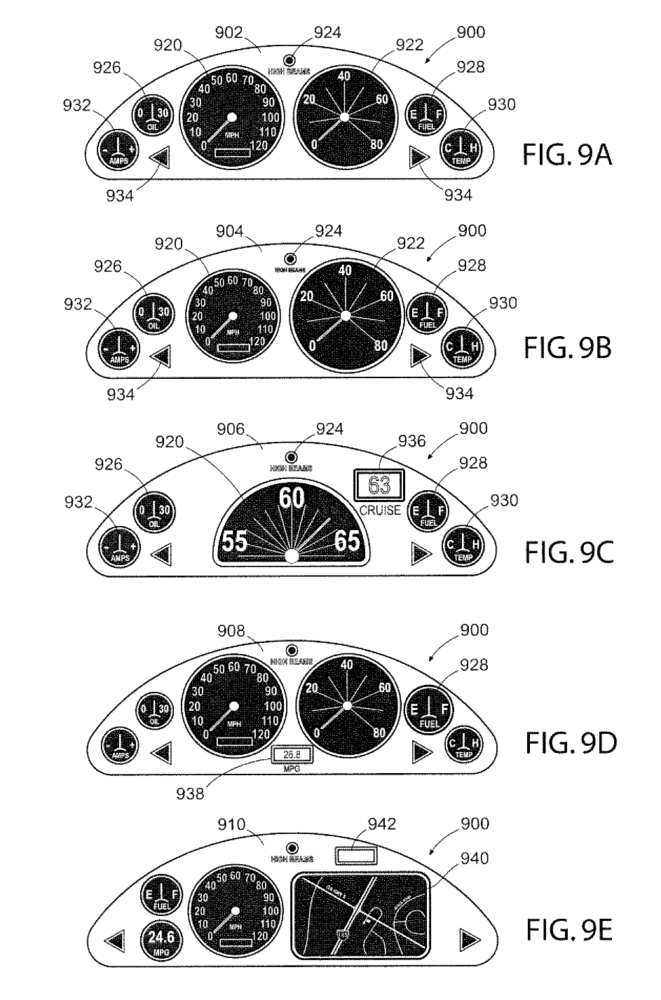

In its simplest form, the user input device 802 allows a user to select between various pre-programmed operational modes that provide different display characteristics. For example, a mode selector switch 804 may be provided which allows a user to select from a list of modes, such as sport, highway, economy and normal mode for an automobile. The selection of different modes results in the display of images having different characteristics. FIGS. 9A-9E show examples of the different images generated by various operation modes of the instrument panel 900.

The instrument panel 900 may be capable of providing images of a variety of gauges such as a speedometer 920, tachometer 922, headlight indicator 924, oil pressure gauge 926, fuel gauge 928, temperature gauge 930, voltmeter 932, turn signal indicator 934, cruise control indicator 936, fuel economy indicator 938, and a navigation indicator 940 among others. The characteristics of the gauges may change, and gauges may be added or removed, depending upon the particular mode in which the instrument panel is operating. For example, in a default mode a display panel 900 may display image 902 as shown in FIG. 9A with the gauges in a default size and location. If a user selects a sport mode then the display panel 900 may display image 904 shown in FIG. 9B which has an enlarged tachometer 922. In a highway mode shown in FIG. 9C the displayed image 906 may have an enlarged cruise control gauge 936 and an enlarged portion of the speedometer 920 in the range of typical highway speeds. In an economy mode (FIG. 9D) the display panel 900 may generate an enlarged image 908 of a fuel economy indicator 938 and a fuel gauge 928. In a trip mode (FIG. 9E) the display panel 900 may generate an image 910 that more conspicuously displays a navigation system 940 and a range indicator 942, It is contemplated that a variety of different modes could also be established which provide different display characteristics, including color, brightness, and layout.

The different operational modes may be stored in memory 512 of the display module 504 as various instruction sets that may be used by the processor 510 of the display module 504 to generate appropriate control signals. The display module 504 is adapted to receive a user selection signal from the user input device 802 indicating a desired operational mode. For example, if a user moves the switch 804 of the switch selector 802 to highway mode, then a signal is sent to the display module 504 indicating that highway mode has been selected. When the selection signal is received at the display module 504, the processor 510 retrieves the associated instruction set for the selected mode from memory 512 and proceeds to process data signals and generate control signals in accordance with the selected mode. Thus, if the highway mode is selected, the generated display will took similar to FIG. 9C, whereas if the economy mode is selected, the generated display may look like FIG. 9D.

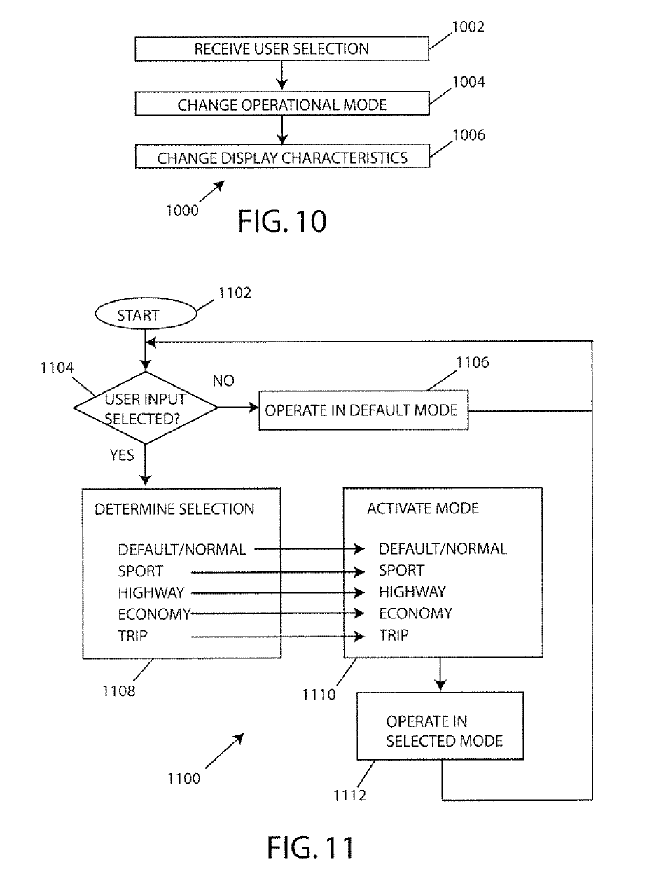

FIG. 10 shows an exemplary method 1000 of the invention. At block 1002 a user input is received. This input may be provided by a variety of means. In the exemplary embodiment shown in FIG. 8 a user selects a mode on the mode selector device 802 so that a selection signal is sent to the display module 504. At block 1004 the operational mode is updated to the mode selected by the user. For example, upon receipt of the selection signal from the user input device 802 the processor 510 of the display module 504 may retrieve the instructions associated with the selected mode from memory 512 and generate an updated control signal to the drive unit 502. At block 1006 the display generates images in accordance with the selected operational mode.

In addition to the predetermined modes discussed above, the user may create a personalized mode that can be activated when the user operates the vehicle. For example, an operator may be prompted to enter his or her preferences on an input device, such as desired colors, brightness levels, gauges, etc. This mode could then be saved in memory and associated with the operator. For example, the user could be assigned a user identification which could be associated with his selected preferences. The operator could then simply provide his user identification, such as by moving a user switch (not shown) to select his or her personalized mode the next time he operates the vehicle. In this way an operator can quickly select his display preferences.

The user may provide his identification by a variety of means such as manually pressing a switch associated with that user, such as placing a toggle switch in a particular position, the toggle switch having multiple positions, each representing a different user. An operational mode may also be selected by automatically identifying the user through a user identification means. For example, the weight of the user in an operator seat may be used to identify the user and select an operational mode associated with that user. Other methods may also be used to identify a user and select an associated operational mode, such as a identifying the user's seat position, steering wheel position, employing an identifier chip that may be read when inserted in the ignition of an automobile, using a radio frequency identification (RFID) tag that is activated when within proximity of the vehicle, etc. This automatic selection of the operation mode is especially desirable in vehicles that have multiple operators who have different preferences.

FIG. 11 shows a logic diagram 1100 of an exemplary method of the invention. At block 1102 the process is started. A user may be prompted to select a desired operational mode. For example, a message may be displayed on the display panel 202 prompting the user to select from a list of predetermined modes or to enter a menu to select preferences for a personalized mode. This may happen upon the occurrence of a predetermined event, such as when an operator enters a vehicle or initiates use of the vehicle such as by placing a key in the ignition or some other event. As previously discussed, operator identification technology may be used to identify a user and select an operational mode previously associated with the user.

At block 1104 a determination is made whether a user has selected a display scheme. For example, the display module 504 may check to see if a selection signal has been received. If no selection signal is detected then the instrument panel may operate in a default mode at block 1106 or the mode employed when the vehicle was last operated. If a user selection signal is received, then a determination is made at block 1108 as to what mode was selected and at block 1110 the selected mode is activated. For example, as discussed above a processor 510 of a display module 504 may retrieve instructions associated with the selected mode from memory 512 and generate control signals in accordance with the instructions that are sent to the drive unit 502. The drive unit 502 may then generate appropriate drive voltages to produce a display image in accordance with the selected mode. At block 1112 the system operates in the selected mode until a different mode is selected.

In another aspect of the invention, a dynamic instrument panel is provided in which the characteristics of the images displayed on the display panel may be changed automatically if certain criteria are met. For example, a particular operational mode may be selected or a characteristic of a displayed image may be changed in response to the occurrence of a particular event. In one aspect, the characteristics of the displayed image may change in response to an action by a user. For example, if a user turns on the cruise control of an automobile, then a cruise control gauge may be enlarged and re-located on the display panel while other gauges are re-located or resized. Likewise, if a user operates a navigation system, a navigation gauge may be displayed on the display panel. Other triggering events may also be used such as events associated with the performance of the vehicle. For example, if the rpms of the vehicle exceed a predetermined value, then the color and size of the tachometer may be changed; if a vehicle is low on fuel the displayed image of the fuel gauge may be enlarged and relocated to the center of the instrument panel. If the vehicle exceeds a predetermined speed, then the speedometer may turn a different color. Other triggering events, such as triggering events from external sources, such as the receipt of a telephone call, and associated display changes will become apparent to those skilled in the art.

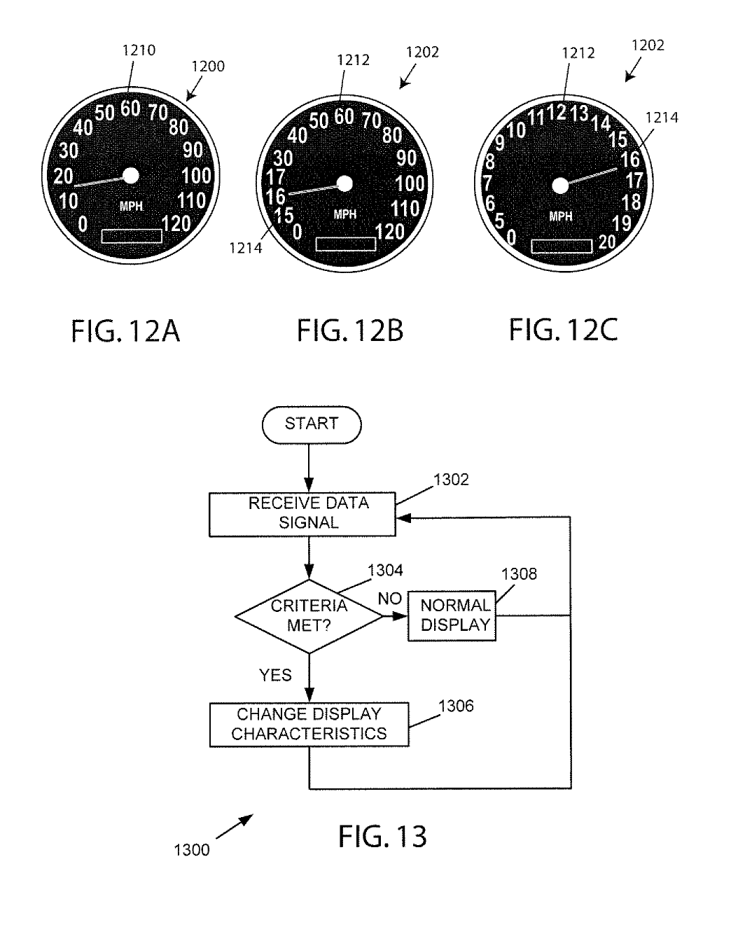

The ability to dynamically change the operational mode or display characteristics of the vehicle gauges provides improved display performance by allowing for the efficient use of the limited space available in an operator's prime viewing area and allowing the characteristics of the gauges to change in accordance with the relevance of the gauge. For example, in the mechanical gauges of the prior art as shown in FIG. 12A, the speed indicia 1210 of the speedometer 1200 are static so the same indicia are used regardless of whether the vehicle whether it is traveling at 1 mph or 150 mph. Due to the limited display space and the fixed indicia it is difficult to create a gauge that provides an accurate speed indication for all speeds. For example, if the vehicle speed limit is 18 miles per hour, it is difficult to accurately indicate this speed on the gauge shown in FIG. 12A, as the speedometer shows indicia from 0 to 165 miles per hour with few indicators near the 18 mph range. The instrument panel of the present invention as shown in FIG. 121, however, can be adapted to recognize that a user is traveling at a low rate of speed for more than a predetermined amount of time, and in response, enlarge the speedometer indicia 1212 on the speedometer 1202 in proximity to the vehicle's speed as shown in FIG. 12B, which allows a user to more accurately determine vehicle speed. This could also be adapted to other gauges to enlarge indicia in proximity to a measured value.

A variety of rules or schemes can be provided to govern the dynamic changes of the display characteristics and these rules could be stored in the display module 504 in a manner similar to that discussed above relating to the storage of operational modes.

FIG. 13 shows an exemplary method 1300 for providing a dynamic display. At block 1302 a data signal is received and decoded. These data signals may be received from a variety of sources, such as from a vehicle electronic system 506 as shown in FIG. 5. The data signals may be received by a display module 504 that may include various devices, such as codecs, filters, analog to digital converters, processors, etc., to decode and process the received signal. At block 1304 a determination is made whether the data retrieved from the data signal meets predetermined criteria. For example, a plurality of different vehicle performance variables may be assigned triggering criteria so that when a measured value meets specified criteria it triggers an adjustment to the display characteristics. Thus, if the necessary parameter(s) is met, then the characteristics of the image displayed on the display panel are updated at block 1306. Changes to the display characteristics may include, by way of example and not limitation, the size, location, shape, color, brightness, or other characteristics of one or more gauges. If the criterion is not met, then at block 1308 the image is displayed as normal.

The vehicle may be continuously monitored and the characteristics of the displayed images dynamically updated. This feature allows the instrument panel to intelligently provide data to the limited space available in the instrument panel by resizing and relocating different gauges dynamically. A gauge that is rarely used may be provided in an inconspicuous portion of the display in small size most of the time. When the system determines that the relevance of the gauge has increased then characteristics of that gauge can be changed such as the location, color, size, and shape of the gauge. In addition, the gauge may be flashed or otherwise modified. For example, a tire pressure gauge may be shown off center of the display in a small size when the tire pressure is within an acceptable range and then increased in size and moved to the center of the instrument panel if the tire pressure falls out of an acceptable range. In another example, the system may be programmed to identify when a user leaves a turn signal on for an extended period of time and accordingly enlarge, change the color or brightness, or otherwise change the characteristics of the turn signal indicator on the display panel to alert the operator.

In another exemplary embodiment, data signals are received from a navigation system to determine the location of the vehicle. Characteristics of the display panel may then be changed in response to the vehicle location. For example, if the location is determined to be in the United States, then the speedometer may indicate speeds in miles per hour, whereas if the location is determined to be in Canada, then the speedometer may indicate speeds in kilometers per hour. Likewise, if it is determined that the vehicle is on a particular road having a particular speed limit, then the characteristics of the speedometer may be changed to indicate the speed limit.

Another advantage of the vehicle display system of the present invention is that it may be used to display data received from a variety of different sources. For example, the display system can display data received from an external source that is coupled to the display system. The instrument panel can thus be adapted to interface with a variety of external devices, such as by way of example and not limitation, MP3 players, personal digital assistants, telecommunications devices, computers, audio players, video players, vehicle diagnostic devices, navigation systems, computer networks, etc.

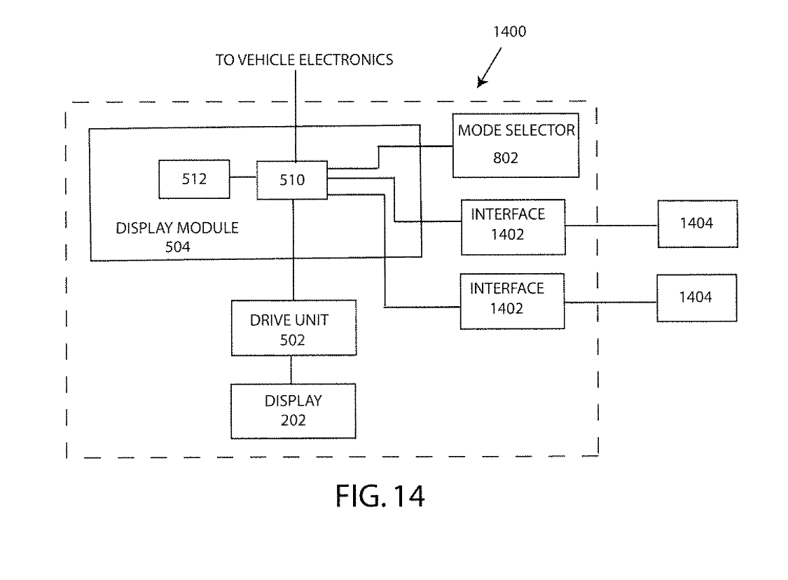

As shown in FIG. 14, a vehicle display system 1400 may include one or more interfaces 1402 adapted to interface with one or more external devices 1404. A display module 504 may be adapted to receive input signals from an external device 1404 and provide control signals to display images on the display panel 202, This allows the external device 1404 to send data through the interface 1402 to the display module 504. Two-way communication between the display system and the external device may also be established.

In one exemplary embodiment, a diagnostic device, such as a vehicle computer code reader may be coupled to the display module 504 to show vehicle diagnostic information on the display panel 202. The interface 1402 is preferably adapted to establish communications with a variety of external device devices 1404. In the exemplary embodiment, the display system 1400 may be provided with a universal serial bus (USB) interface port and adapted to exchange data in accordance with the USB protocol. Other wired ports and interfaces, such as FireWire™, and wireless interfaces, such as IR, RE, ZigBee™ and Bluetooth™ may also be provided.

The display module 504 may be provided with various instructions and rules for governing the use of the external devices 1404. For example, when the display panel 202 is provided as part of an instrument panel, various rules and priorities may be established for determining what is shown on the display panel 202. For example, to prevent distraction of the operator while operating a vehicle, rules may be established which require that the vehicle be in a predetermined state, such as in park, before allowing use of the display by particular external devices, such as a video player.

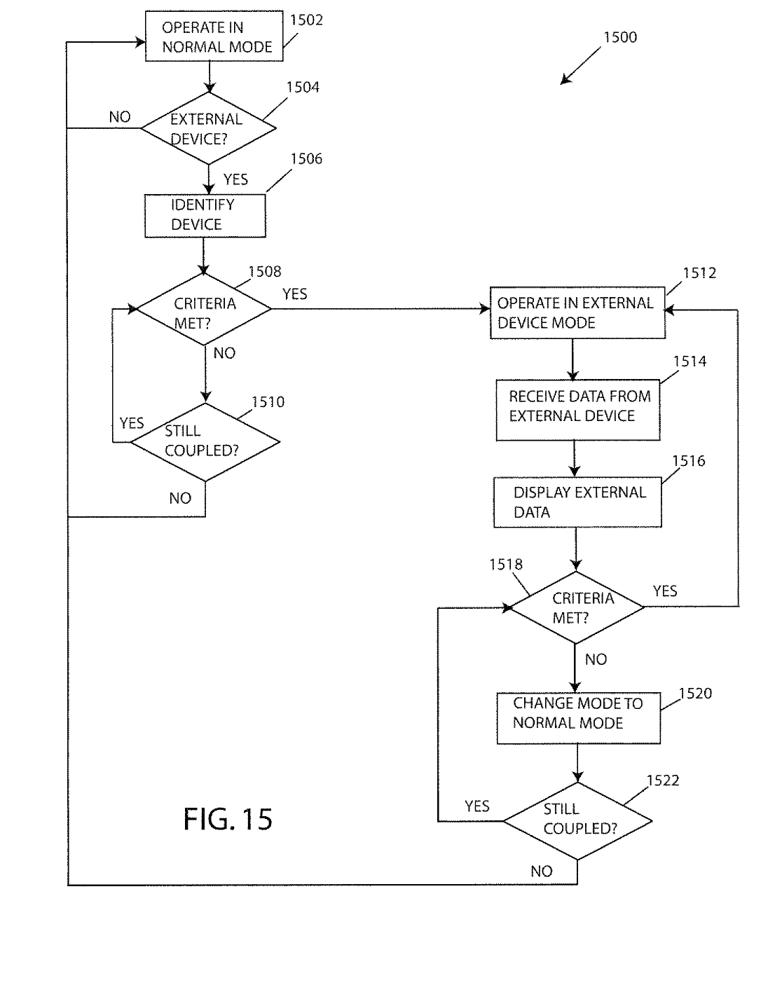

FIG. 15 shows an exemplary method 1500 of the invention for providing images on a vehicle display associated with an external device. At block 1502 the display system operates in a first mode, which may be a default mode or some other mode, which provides images on a display panel according to particular rules. At block 1504 the display system determines whether there is an external device. A variety of methods may be used to detect the external device. For example, the external device may be physically connected to an interface using a connector or may be coupled in some other way such as by RF or IR. Presence activation systems may be used where telecommunication signals are sent from the external device to the display system to alert the display system of the presence of the external device.

At block 1506 the external device is identified. For example, the external device may be identified through a handshaking process of the communication protocol used such as the USB protocol. For example, if a video player is connected to the interface 1406, then a signal including information identifying the external device as a video player is received at the display system 1400. If a presence activation systems is used as discussed above then an identification signal may be sent identifying the device.

Using the identity of the external device, at block 1508 a determination is made whether the necessary criteria is met for displaying data associated with the external device on the display system. For example, one criterion for displaying data associated with a video device may be that the transmission is in park. A variety of different rules may be used depending upon the external device and may include a variety of conditions such as the status of the vehicle or other factors.

If the criteria is not met, then the display system continues to operate in its present mode and a determination is made at block 1510 whether the external device is still coupled to the display system. If the device is still coupled, then another check is made whether the criteria for the external device is met.

If at block 1508 the criteria for the external device is met, then at block 1512 the display system operates in an external device mode in which it receives data from the external device at block 1514 and displays images associated with the external device on the display panel 202 at block 1516.

Another check is then made at block 1518 as to whether the criteria is still met. If the criteria are met then the display system continues to operate in external device mode. If the criteria is no longer met, such as when the external device is a video player and the user moves the vehicle from park gear to drive gear, then at block 1520 the display system reverts back to the previous mode of operation. At block 1522 a determination is made as to whether the external device is still coupled to the display system, and if so, then another check is made at block 1518 as to whether the criteria is met. If the external device is no longer coupled to the display system at block 1522 then the device continues to operate in normal mode.

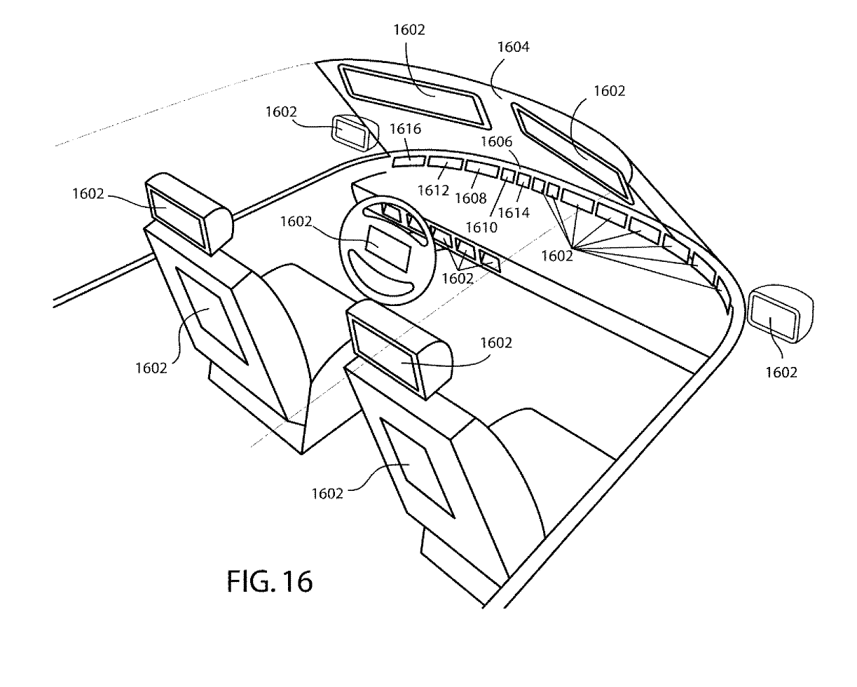

In the exemplary embodiment 200 of a display system of the present invention shown in FIG. 2, the images displayed on the display panel 202 are adapted to resemble that of traditional mechanical gauges and the display panel 202 is arranged in the dashboard of the vehicle to form a vehicle instrument panel 200. The flexibility and addressability of a display system of the present invention obviates many of the limitations imposed by the rigid displays and base panels of the prior art and thereby also allows for the construction of non-traditional vehicle displays. For example, FIG. 16 shows an exemplary embodiment of an instrument panel in which one or more flexible displays 1602 extend along the base of a vehicle windshield 1604 across the width of the vehicle interior, such as from the driver's side window to the passenger's side window in an automobile. This configuration may be achieved by lowering the dashboard 1606 so that the base of the windshield 1604 is visible and placing an addressable and flexible instrument panel along the bottom portion of the windshield. This raises the viewing level of the instrument panel to be more in line with viewing level of the path. Gauges of importance to the driver, such as speedometer 1608, fuel gauge 1610, and tachometer 1612, may be positioned closest to a driver and auxiliary gauges, such as clock 1614 and temperature displays 1616, may be positioned on the periphery. The gauges may be presented as non-traditional images such as by graphs, charts, digital readouts, etc. As discussed above, the location of the gauges may be changed in accordance with a user selection or dynamically if desired.

Furthermore, while the previous embodiments have been discussed largely in the context of a vehicle instrument panel having a single display panel located at a vehicle dashboard, it is also contemplated that a display system of the present invention may incorporate a plurality of display panels which may be provided at a variety of locations of a vehicle. As shown in FIG. 16, display panels may be provided throughout the vehicle such as in a visor, head rest, seat back, side mirror, door panel, etc. as shown in FIG. 16.

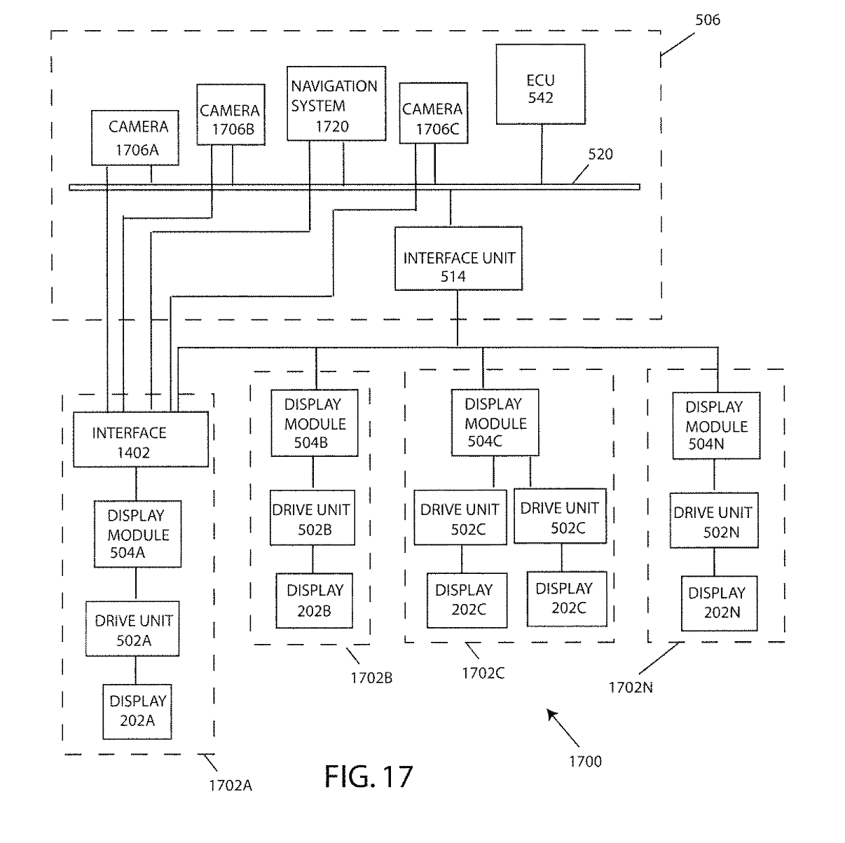

FIG. 17 shows a block diagram of an exemplary embodiment of a vehicle display system 1700 of the invention comprising a plurality of vehicle display subsystems 1702A-N. Each display subsystem may comprise a display module 504, a drive unit 502, and a display panel 202, as discussed above, and be adapted to generate images on a display panel.

As also discussed above, the display modules 504 of a particular display subsystems 1702 may be coupled to an interface unit 514 of a vehicle (FIG. 5) and/or another data source to receive data signals and generate control signals to produce a desired image on an associated display panel.

In the embodiment shown in FIG. 17, a first display subsystem 1702A is coupled to an interface unit 514 of a vehicle and a plurality of cameras 1706A-C. The cameras 1706A-C may be coupled to a data bus 520 of the vehicle and/or to one or more display modules 504. The cameras 1706A-C may send data signals associated with images captured by the camera to a display module 504A either over the data bus 520 and through the vehicle interface 514 or directly to the display module 504A through a display interface 1402.

The cameras 1706A-C may be mounted at various locations of the vehicles to capture images of desired areas, such as various areas, commonly referred to as “blind spots”, which are difficult for an operator to see. For example, cameras may be mounted on a vehicle's side mirrors to provide images of the areas to the side of the vehicle, at the rear of the vehicle to provide images of the area behind the vehicle, on the front of the vehicle to provide images of the area in front of the vehicle, on top of the vehicle, etc. Cameras 1706A-C may also be provided with additional sensing technology such as infrared, night vision, rangefinders, etc. to provide additional data signals.

The display subsystems 1702A-N may thus be coupled to a variety of different data sources, such as the cameras 1706A-C, and be adapted to select a particular data source from which to receive a data signal and generate a desired image on the display. For example, a display module 504A may operate in a default mode and provide images using data signals from a first data source and upon the occurrence of a triggering event change modes to receive data signals from a second data source to provide a different image. For example, in a default mode a subsystem may generate images, such as a map, using data signals from a navigation device 1720. If an operator activates a left turn signal then the display module 504A may then switch modes to receive data signals from a side mirror camera 1706A and generate images on the display panel of the blind spot on the driver's side. Likewise, if a right turn signal is activated the display module 504A may switch modes to receive data from a passenger side mounted camera 1706B to generate images of the passenger side blind spot. Similarly, if a user places the vehicle in reverse gear, then the display module may switch modes to receive data from a rear mounted camera 1706C and generate images of an area behind the vehicle. The display modules may be provided with a variety of different schemes for changing modes and switching data sources. Such events may include, by way of example and not limitation, activation of turn signals, navigation systems, flashers, gear changes, seat position, etc. Although most subsystems 1702A-N are shown as having a single display panel 202, it is contemplated that a display module 504 may control multiple display panels 202.

The vehicle interface 514 may provide data signals to the display modules 504A-N to indicate the occurrence of these triggering events. It is also contemplated that the vehicles electronic system may be adapted to activate and deactivate particular devices upon the occurrence of such triggering events such as activating and deactivating various cameras 1706A-C.

While the discussion above focused primarily on display systems that form an instrument panel, as shown in FIG. 16, display panels 202A-D may be located throughout the vehicle, both inside and exterior of the vehicle cabin. For example, a first display 202A may be located on a side mirror 1602, a second display 202B may be located on a sun visor 1604, a third display 202C may be located on a dashboard 1606, a fourth display 202D may be located on a head rest 1608, a fifth display 202E may be located on a rearview mirror 1610, a sixth display 202F may be located on a seatback 1612, and a seventh display may be located at a rear window 1614 of the vehicle. As discussed above, what is displayed on these display panels 202A-E at any particular time may be determined by the various schemes stored in the various display modules 202. For example, the display module 202B located in the sun visor 1604 may be deactivated when the visor 1604 is in a stowed position and activated to show an image of a map using data signal from a navigation system when the visor 1604 is moved into an operable position. A display could be located on an exterior body panel of a vehicle (not shown). An external display could indicate vehicle operation (turn signals, hazard lights, etc) or display vehicle customization (simulated paint effects, stripes, etc) or still or video advertising.

Again, the above-described and illustrated embodiments of the present invention are merely examples of different implementations, and are set forth for a clear understanding of the principles of the invention. Variations and modifications may be made to the above-described embodiments, and the embodiments may be combined, without departing from the scope of the following claims. For example, in the exemplary embodiments shown herein, the images provided by the display panel resembled mechanical gauges but the images could take other forms such as bar graphs, digital readouts, icons and symbols, etc.

What is claimed is:

1. A vehicle instrument panel, comprising:
a display panel, said display panel being flexible and addressable and adapted to provide images of one or more vehicle gauges, wherein said display panel is adapted to attach directly to a non-planar vehicle surface.

2. The vehicle instrument panel of claim 1, further comprising:
a display module coupled to said display panel, said display module adapted to receive a data signal from a vehicle and provide an associated control signal to said display panel.

3. A dynamic vehicle display system, comprising:
a display module adapted to receive data signals from a vehicle and generate control signals in response to said data signals, said control signals adapted to generate images on a display, said images having variable display characteristics; and
an addressable display panel coupled to said display module and adapted to receive said control signals and generate said images in response to said control signals.

4. The dynamic vehicle display system of claim 3, further comprising a drive unit adapted to receive said control signals from said display module and send associated drive signals to said display panel to generate said images on said addressable display panel.

5. The dynamic vehicle display system of claim 3, wherein said desired images comprise at least one gauge.

6. The dynamic vehicle display system of claim 3, wherein said addressable display panel is an electroluminescent display panel.

7. The dynamic vehicle display system of claim 3, wherein said display module is adapted receive data signals from an external device and send associated control signals to said display panel to generate images associated with said external device.

8. The dynamic vehicle display system of claim 7, further comprising:
an interface for coupling said display module to said external device.

9. The dynamic vehicle display system of claim 8, further comprising an external device coupled to said display module.

10. The dynamic vehicle display system of claim 9, wherein said external device is a video device.

11. The dynamic vehicle display system of claim 3, wherein said display module is adapted to generate said control signals in accordance with a predetermined scheme.

12. The dynamic vehicle display system of claim 3, wherein said display module is adapted to operate in a plurality of operational modes and generate control signals in accordance with a selected operational mode.

13. The dynamic vehicle display system of claim 12, wherein said display module is provided with a predetermined scheme for selecting an operation mode from said plurality of operation modes.

14. The dynamic vehicle display system of claim 13, wherein said display module is adapted to select an operational mode in response to an occurrence of a predetermined event.

15. The dynamic vehicle display system of claim 14, wherein said predetermined event is an operational event of said vehicle.

16. The dynamic vehicle display system of claim 15, wherein said predetermined event is a selection of an operational mode by a user.

17. The dynamic vehicle display system of claim 3, wherein said at least one display panel comprises a plurality of display panels.

18. The dynamic vehicle display system of claim 3, wherein said display panel is adapted to conform to a non-planar surface of a vehicle.

19. A dynamic vehicle display, comprising:
an addressable display, adapted to receive data signals from a vehicle and generate an associated image, wherein said addressable display is adapted to modify at least one characteristic of a generated image upon occurrence of a predetermined event.

20. The vehicle instrument panel of claim 19, wherein said display comprises a single integrated display panel.

21. The vehicle instrument panel of claim 19, wherein said display comprises a plurality of display panels.

22. The dynamic vehicle display system of claim 19, wherein said characteristic is a gauge location.

23. The dynamic vehicle display system of claim 19, wherein said characteristic is a gauge size.

24. The dynamic vehicle display system of claim 19, wherein said wherein said characteristic is a gauge shape.

25. The dynamic vehicle display system of claim 19, wherein said wherein said characteristic is a gauge color.

26. The dynamic vehicle display system of claim 19, wherein said wherein said characteristic is a gauge brightness.

27. The dynamic vehicle display system of claim 19, wherein said wherein said characteristic is a gauge range.

28. A dynamic vehicle display system, comprising:
a display module having a plurality of operational modes, said display module
adapted to receive a data signal from a vehicle and generate a control signal in response to said data signal in accordance with a selected operational mode; and
an addressable display panel coupled to said display module and adapted to receive said control signal and generate an image.

29. The dynamic vehicle display system of claim 28, wherein said display module is adapted to change the selected operational mode upon occurrence of a predetermined event.

30. The dynamic vehicle display system of claim 28, wherein said predetermined event is an operational parameter of a vehicle.

31. A vehicle display system, comprising:
a plurality of display panels, said plurality of display panels being flexible and addressable; and
at least one display module coupled to said display panels, said at least one display module adapted to receive a data signal from a vehicle and generate a control signal to said plurality of display panels to generate a desired image.

32. The vehicle display system of claim 31, wherein said plurality of display panels are positioned throughout a vehicle.

33. A vehicle display system, comprising:
a display module adapted to receive a data signal from a data source and generate a control signal in response to said data signal;
a driver unit adapted to receive said control signal from said display module and provide a driver signal in response to said control signal; and
a display panel adapted to receive said driver signal and generate an associated image.

34. The vehicle display system of claim 33, wherein said display module is adapted to operate in a plurality of different operational modes, further comprising:
a user input device coupled to said display module, said user input device adapted to receive a user input; and
wherein said display module is adapted to select an operational mode in accordance with said user input.

35. The vehicle display system of claim 33, wherein said operational mode changes at least one characteristic of said image.

36. A dynamic vehicle display system comprising:
an addressable display adapted to receive a data signal from a vehicle and generate an associated image, said addressable display adapted to change at least one characteristic of the image in response to an occurrence of a particular event.

37. The vehicle display system of claim 36, wherein said event is an operational parameter of a vehicle.

38. The vehicle display system of claim 36, wherein said event is a selection of an operational mode by a user.

39. The vehicle display system of claim 36, wherein said characteristic is gauge size.

40. The vehicle display system of claim 36, wherein said characteristic is gauge location.

41. The vehicle display system of claim 36, wherein said characteristic is gauge brightness.

42. The vehicle display system of claim 36, wherein said characteristic is gauge shape.

43. The vehicle display system of claim 36, wherein said characteristic is gauge range.

44. The vehicle display system of claim 36, wherein said characteristic is color.

45. The vehicle display system of claim 36, wherein said display system is adapted to receive a data signal from an external device and display images on said display panel associated with said external device.

46. The vehicle display system of claim 45, wherein said external device is a video device.

47. The vehicle display system of claim 45, wherein said external device is a diagnostic device.

48. A method, comprising:
conforming a flexible and addressable display panel to a surface of a vehicle.

49. The method of claim 48, further comprising attaching said flexible and addressable display directly to said surface.

50. The method of claim 48, further comprising coupling said flexible and addressable display panel to an electronic system of a vehicle.

51. The method of claim 48, further comprising coupling said flexible and addressable display panel to an external device.

52. A method, comprising:
receiving a data signal;
generating an image on an addressable display of a vehicle in response to said data signal, said image having at least one characteristic;
receiving a second data signal from the vehicle; and
changing said at least one characteristic of said image in response to said second data signal.

53. The method of claim 52, wherein said step of receiving a data signal comprises receiving a data signal from said vehicle.

54. The method of claim 52, wherein said step of receiving a data signal comprises receiving a data signal from an external device.

55. The method of claim 52, wherein said at least one characteristic is a gauge location.

56. The method of claim 52, wherein said at least one characteristic is a gauge shape.

57. The method of claim 52, wherein said at least one characteristic is a gauge brightness.

58. The method of claim 52, wherein said at least one characteristic is a gauge color.

59. The method of claim 52, wherein said at least one characteristic is a gauge range.

60. A method, comprising:
selecting an operational mode of an addressable vehicle display from a plurality of operational modes, wherein each said selected operational mode determines at least one display characteristic of an image generated on said addressable vehicle display.

61. The method of claim 60, wherein said operational mode is determined in accordance with a predetermined scheme.

62. The method of claim 60, wherein said operational mode is determined by the identity of the operator.

63. The method of claim 61, further comprising the step of identifying said operator.

64. The method of claim 60, wherein said operational mode is selected by user input.

65. The method of claim 60, wherein said operational mode is selected in response to an occurrence of a predetermined event.

66. A method of dynamically changing characteristics of a vehicle display, comprising:
providing an image on an addressable vehicle display panel;
detecting the occurrence of a triggering event; and
changing at least one characteristic of said image in response to said occurrence.

67. A method, comprising:
providing an arrangement of gauges on an instrument panel; and
automatically modifying said arrangement in response to a triggering event.
